(19) United States
(12) Patent Application Publication
(10) Pub. No.: US 2020/0069068 A1
(43) Pub. Date: Mar. 5, 2020

(54) Bed Platform

(71) Applicant: Overman International Corporation, Dandridge, TN (US)

(72) Inventors: Trevor Hodgson, Dandridge, TN (US); Gary Slone, Dandridge, TN (US)

(73) Assignee: Overman International Corporation, Dandridge, TN (US)

(21) Appl. No.: 16/552,446

(22) Filed: Aug. 27, 2019

Related U.S. Application Data
(60) Provisional application No. 62/723,665, filed on Aug. 28, 2018.

(51) Int. Cl. A47C 19/00; F16B 12/52; F16B 12/10

(52) U.S. Cl. CPC A47C 19/005; F16B 2012/106; F16B 12/10; F16B 12/52

(57) ABSTRACT

A bed platform includes a pair of platform sides, each having a bracket receiver; a pair of interfitting brackets received by the bracket receivers, and a leg assembly installed on each of the brackets fixedly connecting the brackets.

### CROSS REFERENCE TO RELATED APPLICATION

This application claims priority to U.S. Provisional Application Ser. No. 62/723,665 entitled BED PLATFORM, filed Aug. 28, 2018, incorporated by reference herein in its entirety.

### FIELD

The present disclosure relates to bed platforms. More particularly, the disclosure relates to a bed platform that improves over conventional bed platforms in design, material construction and assembly, is readily shipped via commercial carriers to end users such as home owners and the like, and is readily assembled by the end user.

### BACKGROUND

Improvement is desired in the provision of bed platforms. Conventional bed platforms desire improvement in design, material construction and assembly.

What is desired is an improved bed platform made that is able to be compactly packaged in a disassembled state so as to be readily shipped via commercial carriers to end users such as home owners and the like. Further, it is desired that such a bed platform would be able to be readily assembled by the end user.

### SUMMARY

The disclosure provides a bed platform that is improved over conventional bed platforms in design, material construction and assembly, is readily shipped via commercial carriers to end users such as home owners and the like, and is readily assembled by the end user.

In one aspect, the disclosure provides a bed platform having a pair of platform sides each platform side having a bracket receiver and a pair of interfitting brackets. Each bracket is configured to be received by one of the bracket receivers of the platform sides. The brackets are configured to interfit into one another to provide a unitary bracket when the platform sides are placed in a side-by-side relationship to provide the bed platform. A leg assembly is installable on the unitary bracket to fixedly connect the interfitting brackets of the unitary bracket upon installation of the leg assembly onto the unitary bracket.

In another aspect, a bed platform according to the disclosure includes a pair of platform sides and a pair of interfitting brackets. Each of the brackets is mountable to one of the platform sides and the brackets are configured to interfit into one another to provide a unitary bracket when the platform sides are placed in a side-by-side relationship to provide the bed platform. A leg assembly is installable on the unitary bracket to fixedly connect the interfitting brackets of the unitary bracket upon installation of the leg assembly onto the unitary bracket.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is an exploded view of a bed platform according to the disclosure.

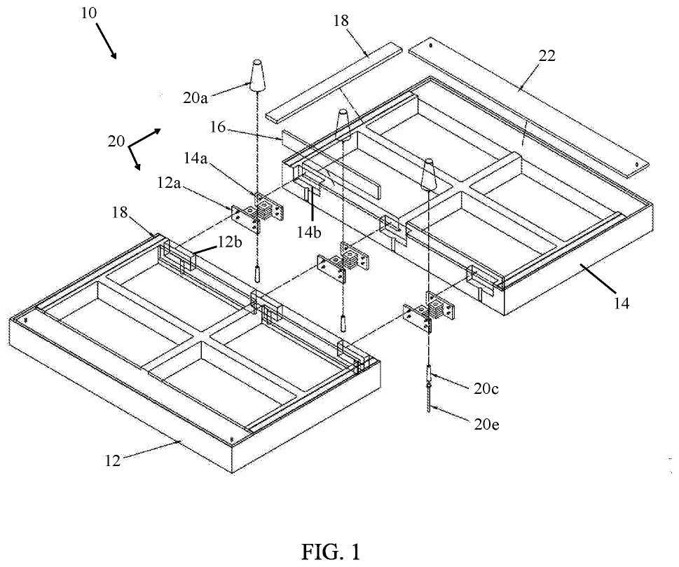

FIG. 2 provides a side view of an assembled bed platform according to the disclosure, with an enlarged view of a portion thereof depicting brackets used to join sides of the platform to assemble the platform, and connection of legs of the platform to the brackets.

FIG. 3 shows an assembled leg system used to support the bed platform above the floor.

FIGS. 4a-4B show a leg pin of the leg system of FIG. 3.

FIG. 5 shows a plunger used during assembly of the leg system of FIG. 3.

FIGS. 6A-6C shows a bracket for one side of the platform.

FIGS. 7A-7C show a bracket for a second side of the platform.

### DETAILED DESCRIPTION

With reference to the drawings, there is shown a bed platform 10 according to the disclosure. The bed platform 10 is an improvement over conventional bed platforms in design, material construction and assembly. In particular, the bed platform 10 is configured to be suitable with a variety of mattress types to support the mattress above the floor, and to facilitate shipping and delivery of the bed platform to home owners and the like via shippers such as Federal Express and United Parcel Service.

The bed platform 10 includes a platform side 12 and an opposite platform side 14. Brackets 12a attach to the platform side 12 and brackets 14a attach to the opposite platform side 14. Mounting boards 16 are attached to the platform sides 12 and 14 and utilized to mount the brackets 12a and 14a to the platform sides 12 and 14, respectively. Tack rails 18 are attached to the platform sides 12 and 14 and utilized to enable flexible sheet material, such as a fabric, to be attached to the bed platform 10 to provide a fabric cover to the bed platform 10. The brackets 12a and 14a are configured to matingly interconnect to one another. The connection between the brackets 12a and 14a becomes fixed upon installation of leg systems 20 having legs 20a onto the brackets 12a and 14b. Additional legs 20a may be mounted to leg rails 22.

The platform sides 12 and 14 are of molded plastic construction, preferably made of expanded polystyrene (EPS) foam. The use of EPS is particularly desirable as it has been discovered that the sides 12 and 14 may be quickly made and are of reduced cost and weight as compared to conventional bed platform materials such as wood or wood composites. In addition, the bed platform 10 made using the sides 12 and 14 made of EPS provides a very durable bed platform. The use of the mounting boards 16, the tack rails 18, and the leg rails 22 is complimentary to the EPS sides 12 and 14 and enable the use of EPS for the sides 12 and 14.

The sides 12 and 14 are molded to define bracket receivers 12b and 14b, respectively, configured for receiving the brackets 12a and 14a. During assembly of the bed platform 10, the brackets 12a and 14a are secured into the bracket receivers 12b and 14b by installing fasteners through apertures of the brackets, with the fasteners securing into the mounting boards 16.

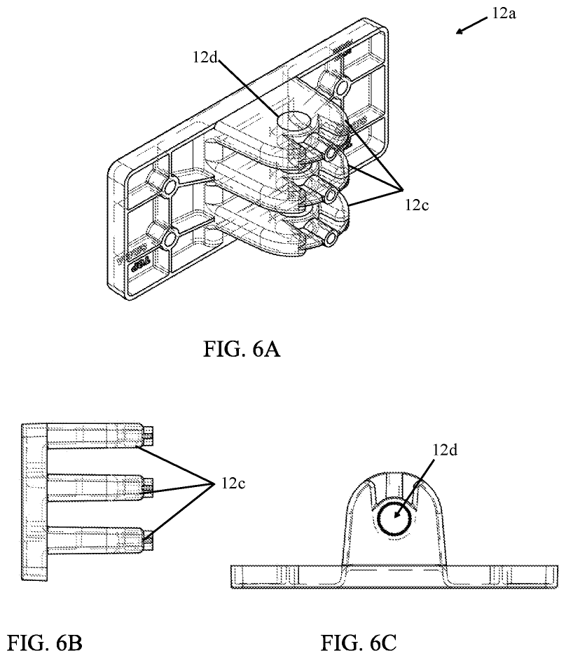

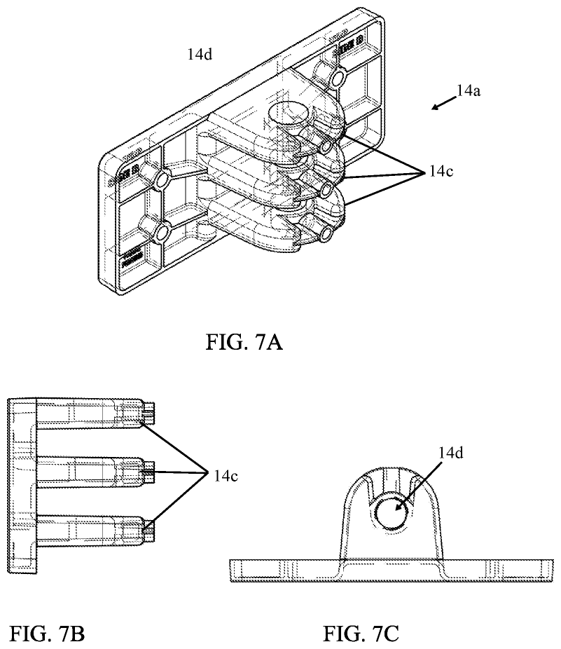

The brackets 12a and 14a are shown in detail in FIGS. 6a-6c and 7a-7c, respectively. Each of the brackets 12a and 14a have alternating spaced apart tabs 12c and 14c, respectively, having aligned bores 12d and 14d through the tabs 12c and 14c. The tabs 12c and 12d are mutually received by the spaces in between with the bores 12d and 14d aligned when the platform sides 12 and 14 are positioned in a side by side relationship with the brackets 12a and 14a oriented in this interconnected relationship. Installation of the leg systems 20 then serves to install the legs 20a and fix the brackets 12a and 14a together to secure the sides 12 and 14 together.

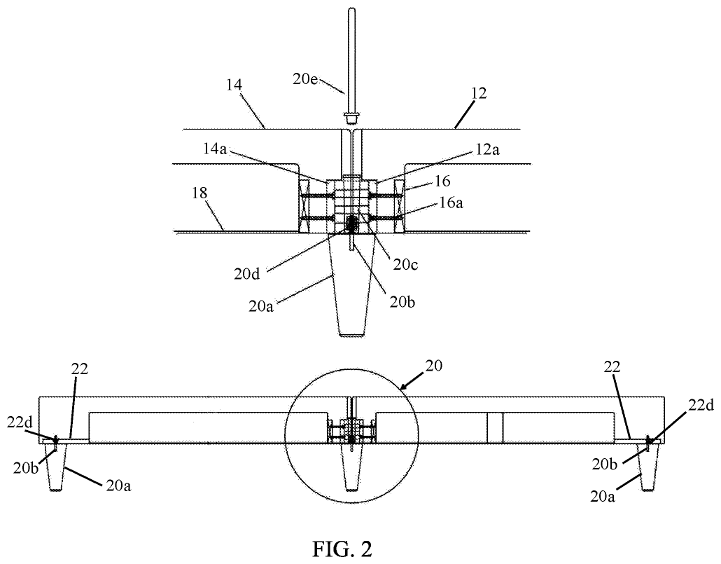

The mounting boards 16 are elongate rigid members and are preferably made of wood or like material than can reliably receive and retain a threaded fastener such as a screw 16a (FIG. 2). It is observed that EPS does not reliably receive threaded fasteners. Thus, when EPS is used for the platform sides 12 and 14, the mounting boards 16 are desirably fixed to the platform sides 12 and 14 behind the bracket receivers 12b and 14b as by adhesively securing the boards 16 to the platform sides 12 and 14 using an EPS compatible glue or the like.

The tack rails 18 are elongate rigid members and are preferably made of wood, cardboard, or like material than can reliably receive and retain a tack or staple. It is observed that EPS does not reliably receive tacks and staples. Thus, when EPS is used for the platform sides 12 and 14, the tack rails 18 16 are desirably fixed to the platform sides 12 and 14 as by adhesively securing the rails 18 to the platform sides 12 and 14 using an EPS compatible glue or the like. Tacks or staples or the like may then be used with the tack rails 18 and a fabric cover to attach a fabric cover to the bed platform 10.

The leg systems 20 are installed onto the opposed connected brackets 12a and 14a when the facing adjacent platform sides 12 and 14 are positioned adjacent one another to connect the opposed pairs of the brackets 12a and 14a. Installation of the leg systems 20 serve to fix the connection of the brackets 12a and 14a and provide assembly of the bed platform 10.

With reference to FIG. 2, the leg systems 20 include the legs 20a. The legs 20a have a threaded hanger bolt 20b connected to an upper end of the leg 20a, a leg pin 20c, an insert 20d, and a plunger 20e.

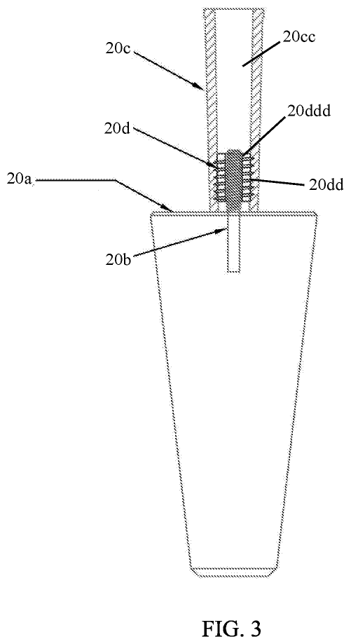

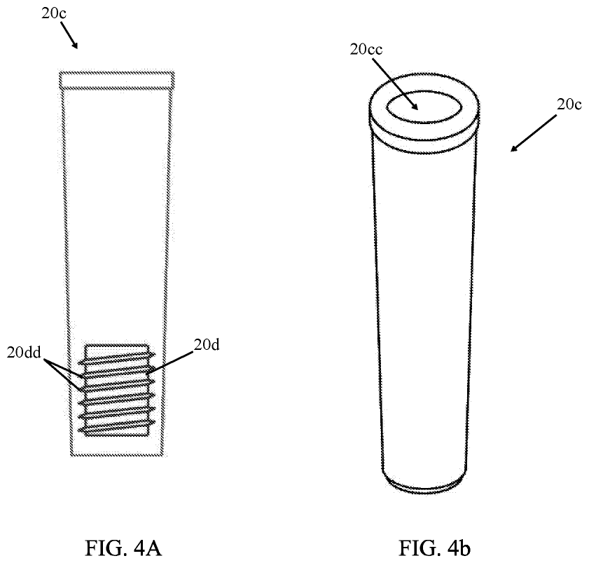

During installation, the brackets 12a and 14a are oriented relative to one another to be interconnected so that the bores 12d and 14d of the brackets 12a and 14a are aligned, and the leg pin 20c is inserted through the aligned bores 12d and 14d of the brackets 12a and 14a. The insert 20d is then inserted into an interior conical or tapered cavity 20cc of the leg pin 20c (FIGS. 3 and 4). The insert 20d has a rogous exterior surface 20dd provided as by external threads or projections or the like configured to frictionally engage the interior walls of the cavity 20cc.

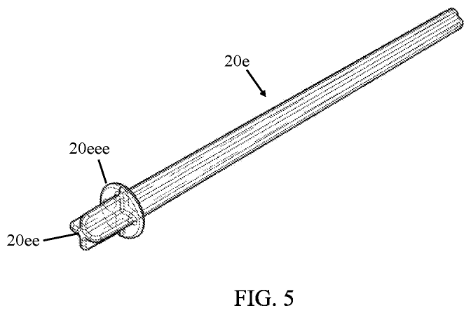

The insert 20d is then tamped to the bottom of the cavity 20cc thereof using the plunger 20e to frictionally wedge it into position in the leg pin 20c at a location where the diameter of the insert 20d is larger than the diameter of the interior taper of the leg pin 20c. The plunger 20e is shown in detail in FIG. 5 and includes a centering disk 20ee and a lower end 20eee configured to bear against the insert 20d.

The leg 20a is then positioned so that the threaded hanger bolt 20b can threadably engage internal threads 20ddd of the insert 20d. The leg 20a is then rotated to thread the bolt 20b into the internal threads 20ddd of the insert 20d until the leg 20a is snugly against and connected to the brackets 12a and 14a, which serves to lock the brackets 12a and 14a together.

The platform assembly and connecting structures are unique in a number of aspects. In one aspect, the wide profile of the brackets allows force to be spread across a greater surface area and be attached directly to the platform. The leg pin 20c with the insert 20d is an improvement that enables a standard furniture leg to be inserted into the leg pin 20c. The feature of the plunger 20e enables seating the leg pin 20c in the brackets 12a and 14a.

The leg rails 22 are elongate rigid members and are preferably made of wood or like material than can reliably receive and retain a threaded insert 22a for threadably receiving the hanger bolt 20b of the leg 20a. The threaded insert 22a is similar to the insert 20d in that it is fixed to the leg rail 22 and includes an internal threaded bore for receiving the hanger bolt 20b. It is observed that EPS does not reliably receive threaded fasteners. Thus, when EPS is used for the platform sides 12 and 14, the leg rails 22 are desirably fixed to the platform sides 12 and 14 as by glue. The legs 20a may then be installed as by threading the bolts 20b into the inserts 22a.

The bed platform 10 advantageously improves over conventional bed platforms in design, material construction and assembly, and is readily shipped via commercial carriers to end users such as home owners and the like, and is readily assembled by the end user.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

1. A bed platform, comprising: a pair of platform sides each platform side having a bracket receiver; a pair of interfitting brackets, each bracket configured to be received by one of the bracket receivers of the platform sides, the brackets configured to interfit into one another to provide a unitary bracket when the platform sides are placed in a side-by-side relationship to provide the bed platform; and a leg assembly installable on the unitary bracket to fixedly connect the interfitting brackets of the unitary bracket upon installation of the leg assembly onto the unitary bracket.

2. The bed platform of claim 1, wherein the platform sides are made of EPS.

3. The bed platform of claim 1, wherein the interfitting brackets each define a through bore and the leg system includes a leg pin having an insert located therein for threadably receiving a threaded bolt of a leg.

4. The bed platform of claim 3, wherein the leg pin has an interior cavity into which the insert is located.

5. The bed platform of claim 4, wherein the insert includes a rough exterior surface configured to frictionally engage the interior cavity.

6. The bed platform of claim 5, wherein the interior cavity of the leg pin is tapered.

7. The bed platform of claim 6, further comprising a plunger configured to frictionally press the insert into the leg pin to frictionally couple the rough exterior surface of the insert to the interior cavity.

8. The bed platform of claim 1, further comprising bracket mounting boards secured to the platform sides behind the bracket receivers, with the interfitting brackets fixed to the mounting boards.

9. The bed platform of claim 1, further comprising leg rails secured to the platform sides, the leg rails including inserts having internal threads for receiving a threaded bolt of a leg.

10. A bed platform, comprising: a pair of platform sides; a pair of interfitting brackets, each of the brackets mountable to one of the platform sides, the brackets configured to interfit into one another to provide a unitary bracket when the platform sides are placed in a side-by-side relationship to provide the bed platform; and a leg assembly installable on the unitary bracket to fixedly connect the interfitting brackets of the unitary bracket upon installation of the leg assembly onto the unitary bracket.

11. The bed platform of claim 10, further comprising a bracket receiver located on each of the platform sides and configured to receive one of the brackets.

12. The bed platform of claim 10, wherein the platform sides are made of EPS.

13. The bed platform of claim 10, wherein the interfitting brackets each define a through bore and the leg system includes a leg pin having an insert for threadably receiving a threaded bolt of a leg.

14. The bed platform of claim 12, wherein the leg pin has an interior cavity into which the insert is located.

15. The bed platform of claim 13, wherein the insert includes a rough exterior surface configured to frictionally engage the interior cavity.

16. The bed platform of claim 14, wherein the interior cavity of the leg pin is tapered.

17. The bed platform of claim 15, further comprising a plunger configured for frictionally inserting the insert into the leg pin to frictionally couple the rough exterior surface of the insert to the interior cavity.

18. The bed platform of claim 10, further comprising bracket mounting boards secured to the platform sides behind the bracket receivers, with the interfitting brackets fixed to the mounting boards.

19. The bed platform of claim 10, further comprising leg rails secured to the platform sides, the leg rails including inserts having internal threads for receiving a threaded bolt of a leg.
